(19) United States
(12) Patent Application Publication
(10) Pub. No.: US 2016/0292675 A1
(43) Pub. Date: Oct. 6, 2016

(54) PORTABLE DEVICE, METHOD FOR CONTROLLING PORTABLE DEVICE, STORAGE MEDIUM, AND PROGRAM

(71) Applicant: RAKUTEN, INC., Tokyo (JP)

(72) Inventor: Hideki AKASHIKA, Tokyo (JP)

(73) Assignees: Rakuten, Inc., Tokyo (JP); Rakuten Edy, Inc., Tokyo (JP)

(21) Appl. No.: 14/912,720

(22) PCT Filed: Aug. 19, 2013
(86) PCT No.: PCT/JP2013/072103

§ 371 Date: Jun. 10, 2016

(51) Int. Cl. G06Q 20/36; G06Q 20/02; G06Q 20/38

(52) U.S. Cl. CPC G06Q 20/3678; G06Q 20/3829; G06Q 20/027

(57) ABSTRACT

A convenient electronic money card system in which a portable terminal is carried by the user and performs radio communication with a payment terminal and electronic wallets A to C using a built-in application. When payment is performed, the portable terminal selects any one of the electronic wallets A to C and establishes radio connection therewith and with the payment terminal. The portable terminal relays communication between the selected electronic wallet and the payment terminal, and the payment terminal transmits the balance change information to the electronic wallet, and the electronic wallet that has received this balance change information performs payment by reducing the value balance in accordance with the balance change information. An example of figure depicts a state in which the portable terminal selects the electronic wallet A and the electronic wallet A makes payment to the payment terminal.

### TECHNICAL FIELD

The present invention relates to portable devices, methods for controlling the portable device, storage media, and programs and relates to, for example, what supports circulation of electronic value.

### BACKGROUND ART

In recent years, the use of electronic money has rapidly become widespread. In electronic money, amount information called value is related to money value and payment is performed by the exchange of value.

The user carries an electronic money card incorporating an IC module storing a value balance and performs payment by reducing the value balance by a payment terminal installed in a store.

One user sometimes has a plurality of electronic money cards of the same brand or different brands, and, as a technique of improving the convenience of users in such a case, there is “Mobile Payment Portable Equipment, Card Holder And System, And Payment Method By Changing Use Of IC Card Depending On The Purpose” of Patent Document 1 below.

However, this technique requires a card holder to which a plurality of IC cards are fitted to be carried at all times in a situation in which the IC cards are used, and therefore a method that offers improved convenience has been required.

### CITATION LIST

### Patent Literature

Patent Document 1: JP-A-2003-256751

### DISCLOSURE OF INVENTION

### Problem to be Solved by the Invention

An object of the present invention is to provide service that uses a plurality of payment devices and offers improved convenience.

### SUMMARY OF THE INVENTION

The invention described in claim 1 provides a portable device comprising: a detecting unit that detects a usable payment device of a plurality of payment devices, each having a unit that stores predetermined data and a unit that executes predetermined processing related to the predetermined data based on request information which is input from an external device and outputs response information; and a specifying unit that specifies, from among the payment devices detected by the detecting unit, a payment device which is to be connected to an accepting device by relaying, the accepting device having a unit that inputs request information to a nearby device and a unit that acquires response information to the request information from the device.

The invention described in claim 2 provides the portable device according to claim 1, wherein when a plurality of payment devices are detected by the detecting unit, the specifying unit preferentially specifies a payment device with a relatively high degree of priority in connecting the payment device to the accepting device, a degree of priority which is determined in accordance with a classification of the accepting device.

The invention described in claim 3 provides the portable device according to claim 2, wherein after connecting to the accepting device, the specifying unit preferentially specifies a payment device with a relatively high degree of priority, the degree of priority which is determined in accordance with a classification of the accepting device which is identified based on data which is acquired from the accepting device.

The invention described in claim 4 provides the portable device according to claim 3, further comprising: a plurality of relaying units which are different from one another, wherein the detecting unit detects a payment device which is connectable to any one of the plurality of relaying units, and the specifying unit preferentially specifies a payment device which is connected to a relaying unit which relatively easily increases the degree of priority.

The invention described in claim 5 provides the portable device according to claim 4, wherein the plurality of relaying units connect to the payment device in connection configurations which are different from one another, the classification includes one or more than one classification which gives priority to a required time of a transaction, and if the classification of the accepting device with which connection has been established corresponds to the classification which gives priority to the required time, the specifying unit preferentially specifies a payment device which connects to a relaying unit with a connection configuration whose degree of shortening the required time is relatively high.

The invention described in claim 6 provides the portable device according to claim 5, wherein if the classification of the accepting device with which connection has been established does not correspond to the classification which gives priority to the required time, the specifying unit preferentially specifies a payment device which connects to a relaying unit with a connection configuration whose degree of enhancing an availability of the payment device is relatively high.

The invention described in claim 7 provides the portable device according to claim 5, wherein if the classification of the accepting device with which connection has been established does not correspond to the classification which gives priority to the required time, the specifying unit preferentially specifies a payment device which does not relatively easily enter an unpayable state.

The invention described in claim 8 provides the portable device according to any one of claims 1 to 7, wherein the plurality of payment devices include a portable payment device which is fitted to a relaying unit connectable to a public communication network, and the detecting unit transmits inquiry information to the portable payment device fitted to the relaying unit via the public communication network and the relaying unit and determines that the portable payment device is usable if reply information to the inquiry information is acquired.

The invention described in claim 9 provides the portable device according to claim 8, further comprising: a unit that makes a holding unit hold key information for being authenticated by a transfer restricting unit that restricts data which is transferred to the portable payment device to data from a device authenticated by predetermined key information; and a unit that presents the held key information to be authenticated by the transfer restricting unit.

The invention described in claim 10 provides the portable device according to claim 9, wherein the unit that makes the holding unit hold the key information makes the holding unit hold the key information which is generated in pairing processing for pairing with the relaying unit having the transfer restricting unit.

The invention described in claim 11 provides the portable device according to any one of claims 1 to 7, wherein the plurality of payment devices include a server-side payment device having a unit that stores connection information for establishing connection with one or more than one relaying unit connectable to a public communication network and an outputting unit that executes balance change processing which changes a balance of electronic value which is stored in a portable payment device by inputting balance change information to the portable payment device which is fitted to or built into the one or more than one relaying unit which is connected via the public communication network by the connection information based on the request information which is input from an external device and outputs the response information, and the detecting unit transmits inquiry information to the server-side payment device and, if reply information to the inquiry information is acquired, the detecting unit determines that the server-side payment device is usable.

The invention described in claim 12 provides the portable device according to claim 11, further comprising: a unit that provides, to the specified server-side payment device, key information which is temporarily valid, the key information which is generated in pairing processing with the relaying unit having a transfer restricting unit that restricts data which is transferred to each portable payment device to data including predetermined key information, wherein the outputting unit of the specified server-side payment device attaches the provided key information corresponding to each portable payment device to balance change information which is input to the one or more than one portable payment device via the relaying unit.

The invention described in claim 13 provides a method for controlling a portable device, comprising: a detecting step of detecting a usable payment device of a plurality of payment devices, each having a unit that stores predetermined data and a unit that executes predetermined processing related to the predetermined data based on request information which is input from an external device and outputs response information; and a specifying step of specifying, from among the payment devices detected in the detecting step, a payment device which is to be connected to an accepting device by relaying, the accepting device having a unit that inputs request information to a nearby device and a unit that acquires response information to the request information from the device.

The invention described in claim 14 provides a recording medium on which a program is recorded, the program that makes a computer implement: a detecting function of detecting a usable payment device of a plurality of payment devices, each having a unit that stores predetermined data and a unit that executes predetermined processing related to the predetermined data based on request information which is input from an external device and outputs response information; and a specifying function of specifying, from among the payment devices detected by the detecting function, a payment device which is to be connected to an accepting device by relaying, the accepting device having a unit that inputs request information to a nearby device and a unit that acquires response information to the request information from the device.

The invention described in claim 15 provides a program that makes a computer implement: a detecting function of detecting a usable payment device of a plurality of payment devices, each having a unit that stores predetermined data and a unit that executes predetermined processing related to the predetermined data based on request information which is input from an external device and outputs response information; and a specifying function of specifying, from among the payment devices detected by the detecting function, a payment device which is to be connected to an accepting device by relaying, the accepting device having a unit that inputs request information to a nearby device and a unit that acquires response information to the request information from the device.

### Effect of the Invention

According to the present invention, since the need to bring a payment device physically closer to an accepting device that accepts payment made by the payment device with which connection is established by short-distance radio communication is eliminated, it is possible to provide service that offers improved convenience.

### BRIEF DESCRIPTION OF DRAWINGS

FIG. 1 is a diagram for explaining the outline of this embodiment;

FIG. 2 is a diagram for explaining the configuration of an electronic money system of this embodiment;

FIG. 3 is a diagram depicting the hardware configuration of a portable terminal;

FIGS. 4(a) and 4(b) are a diagrams depicting the hardware configuration of a portable reader/writer;

FIG. 5 is a diagram depicting the hardware configuration of an electronic money card;

FIG. 6 is a diagram depicting the hardware configuration of an electronic money server;

FIG. 7 is a diagram depicting the hardware configuration of a payment terminal;

FIG. 8 is a flowchart for explaining the overall operation of payment processing;

FIG. 9 is a flowchart for explaining the procedures of connection processing;

FIG. 10 is a flowchart for explaining the procedures of connection processing;

FIG. 11 is a flowchart for explaining the procedures of the payment processing;

FIG. 12 is a flowchart for explaining a first modified example;

FIG. 13 is a flowchart for explaining a second modified example;

FIG. 14 is a diagram for explaining a third modified example;

FIGS. 15(a) and 15(b) are a diagrams for explaining a fourth modified example;

FIG. 16 is a flowchart for explaining the procedures which are performed when recharging is performed; and

FIG. 17 is a flowchart for explaining a modified example when recharging is performed.

### DESCRIPTION OF EMBODIMENTS

### (1) Outline of an Embodiment

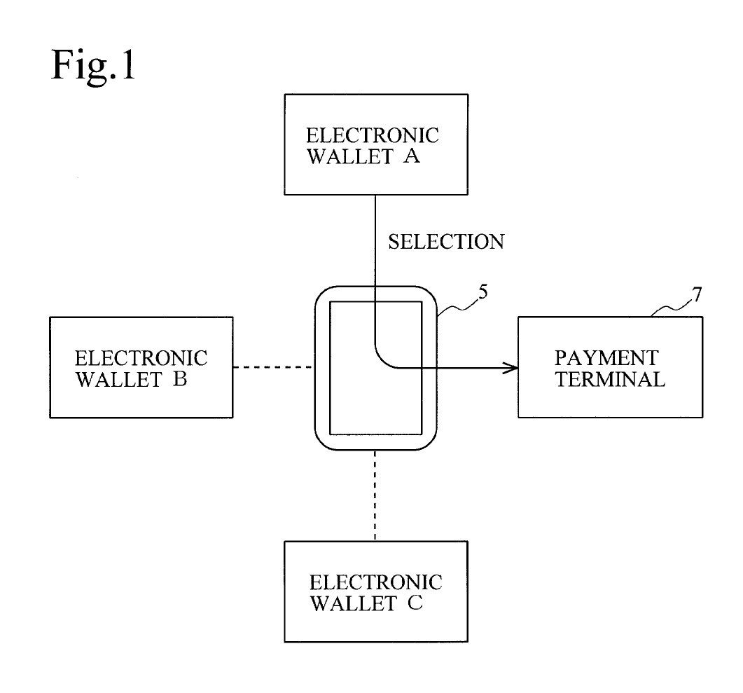

FIG. 1 is a diagram for explaining the outline of this embodiment.

A portable terminal 5 is carried by the user and can perform radio communication with a payment terminal 7 and electronic wallets A to C by using a built-in application.

The payment terminal 7 is installed in a brick-and-mortar store and, for example, the electronic wallet A is installed in a server of an electronic money business operator, the electronic wallet B is kept in user's home, and the electronic wallet C is carried in a bag or an inside pocket of the clothes of the user.

Each electronic wallet stores an independent unique value balance, and, based on the balance change information which is input from the payment terminal 7, each electronic wallet makes payment by reducing the value balance when payment is performed and increases the value balance when recharging is performed.

When payment is performed by using value, the portable terminal 5 selects any one of the electronic wallets A to C and establishes radio connection therewith and establishes radio connection with the payment terminal 7. Then, the portable terminal 5 relays communication between the selected electronic wallet and the payment terminal 7.

After the electronic wallet and the payment terminal 7 are connected by being relayed by the portable terminal 5, the payment terminal 7 transmits the balance change information to the electronic wallet, and the electronic wallet that has received this balance change information performs payment by reducing the value balance in accordance with the balance change information.

An example of FIG. 1 depicts a state in which the portable terminal 5 selects the electronic wallet A and the electronic wallet A makes payment to the payment terminal 7.

As a method by which the portable terminal 5 selects the electronic wallet, various methods, such as a method by which the user manually makes selection as occasion arises and a method by which priorities are assigned to the electronic wallets and selection is made by priorities, are possible.

### (2) Details of the Embodiment

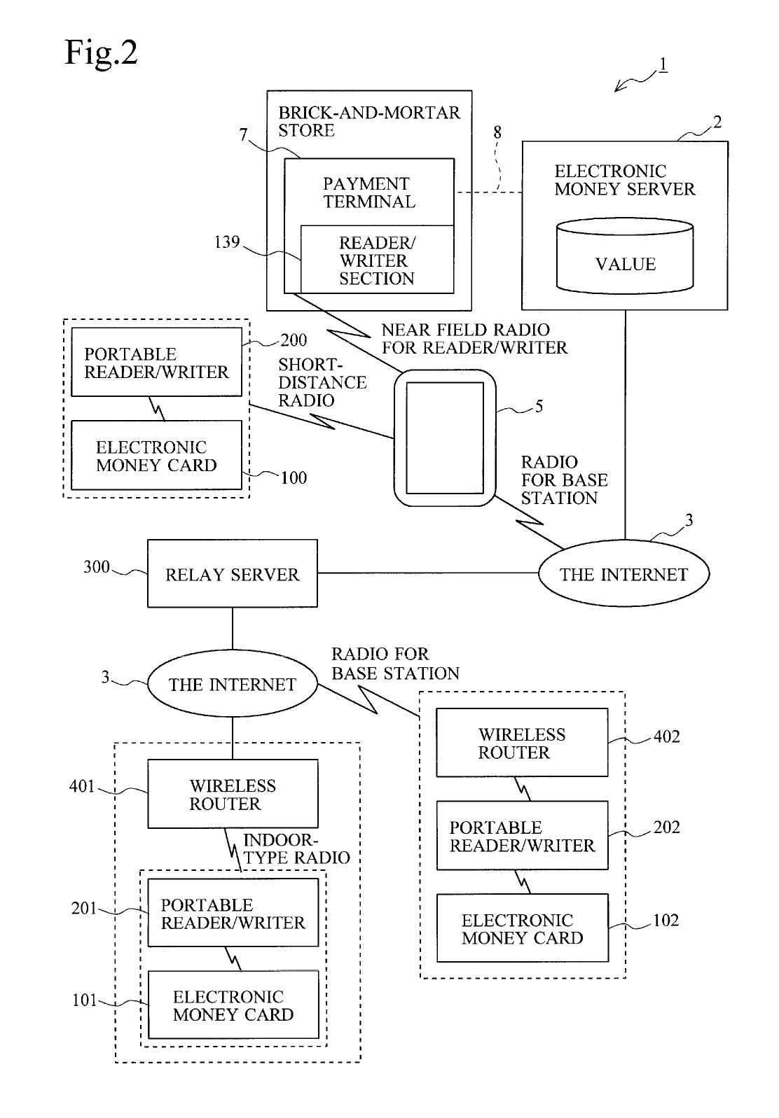

FIG. 2 is a diagram for explaining the configuration of an electronic money system 1 of this embodiment.

The electronic money system 1 is formed of the portable terminal 5, an electronic money server 2, the Internet 3, a relay server 300, the payment terminal 7, wireless routers 401 and 402, portable reader/writers 200 to 202, electronic money cards 100 to 102, a communication line 8, and so forth.

The portable terminal 5 is a portable terminal which is carried by the user, such as a smartphone, a mobile telephone, a game console, or a tablet computer.

The portable terminal 5 has the short-distance radio function (for example, Bluetooth®) by which the portable terminal 5 performs communication with the portable reader/writer 200, the near field radio function for a reader/writer, the near field radio function by which the portable terminal 5 establishes connection with the payment terminal 7, and the radio function for a base station, the radio function by which the portable terminal 5 establishes connection with the Internet 3.

The portable terminal 5 can establish radio connection with a plurality of devices by using these radio functions and relay communication which is performed between these devices.

The payment terminal 7 is installed in, for example, a brick-and-mortar store (a store which is operated in a real-estate property) such as a convenience store and is a terminal which is used when payment by value and recharging are performed.

The payment terminal 7 includes a reader/writer section 139 for performing near field radio communication at a near distance (which is about a few centimeters or shorter) and performs radio communication with the portable terminal 5 by radio communication via the reader/writer section 139.

Then, the payment terminal 7 performs communication with the electronic money cards 100 to 102 and the electronic money server 2 via the portable terminal 5 and increases or decreases the value balances stored in them by transmitting the balance change information to them.

The balance change information is a command that increases or decreases the value balance by a predetermined amount, and a person in charge of the store makes the payment terminal 7 generate the balance change information by operating the payment terminal 7.

The balance change information is a command that updates the value balance to a value which is the value of the value balance reduced by a payment amount when payment is performed and is a command that updates the value balance to a value which is the value of the value balance increased by a recharging amount.

Incidentally, recharging is processing which increases the value balance and, in general, the user has to purchase value by paying money therefor to the brick-and-mortar store or performing credit payment.

Moreover, the payment terminal 7 generates utilization log data that is the record of details of processing of the electronic money cards 100 to 102, the electronic money server 2, and the like and transmits the utilization log data to the electronic money server 2 via the communication line 8. This utilization log data is collected by the electronic money server 2.

As a type of transmission of the utilization log data, there are a synchronous type in which the utilization log data is transmitted to the electronic money server 2 in real time and an asynchronous type in which the utilization log data is accumulated in the payment terminal 7 and the accumulated utilization log data is transmitted to the electronic money server 2 later by batch processing. A type is selected from the viewpoint of location requirements, facility costs, and so forth.

Incidentally, the reader/writer section 139 is originally configured such that the reader/writer section 139 performs direct communication with the electronic money cards 100 to 102 by placing the electronic money cards 100 to 102 in proximity to the reader/writer section 139, and performing payment or recharging by putting the electronic money cards 100 to 102 on a placement surface of the reader/writer section 139 is also possible.

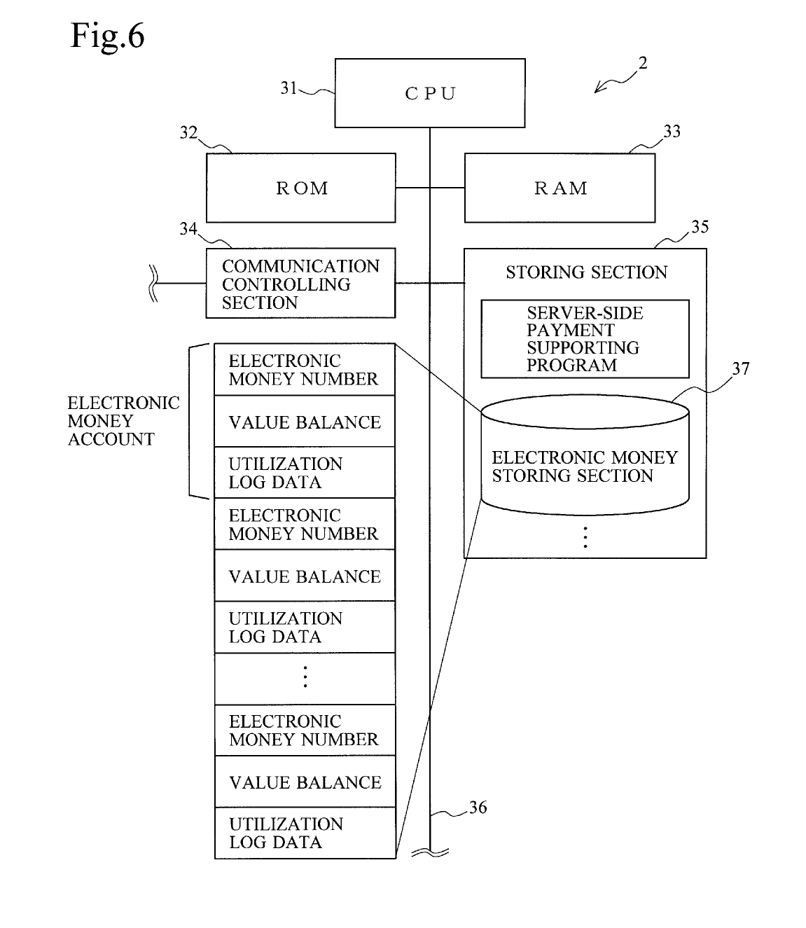

The electronic money server 2 is a server that performs the operations and management of electronic money and allows the user to set an electronic money account in an electronic money storing section 37 (FIG. 6), the electronic money account in which the user holds his/her value balance. The electronic money account is identified by an electronic money number (corresponding to an account number) unique to the account.

Incidentally, in this embodiment, the operations and management of electronic money and the electronic money account are provided in the electronic money server 2, but the operations and management of electronic money and the electronic money account may be provided in separate servers.

The electronic money server 2 acquires the electronic money number of the user from the portable terminal 5 and accesses the electronic money account of the user by using this electronic money number.

Then, the electronic money server 2 increases or decreases the value balance of this account in accordance with the balance change information transmitted from the payment terminal 7 via the portable terminal 5.

As described above, the electronic money server 2 functions as an electronic wallet (an electronic device that holds money value as electronic data and allows the money value to be deposited and withdrawn by a command) of the user.

The Internet 3 is a communication network using various communication media such as radio, optical fibers, and metal lines and mediates communication between various communication devices in accordance with a predetermined protocol.

The Internet 3 includes a base station which accepts access by radio and can establish a radio communication path between the base station and the portable terminal 5 by using an antenna of the base station and an antenna of the portable terminal 5.

The relay server 300 performs communication with the portable terminal 5 via the Internet 3. Incidentally, two Internets 3 are depicted in the drawing, but they are one and the same.

The relay server 300 receives information which specifies the portable reader/writer 201 or 202, transmits a command to the specified portable reader/writer, and starts this portable reader/writer from a standby state. Then, the relay server 300 relays communication between the started portable reader/writer and the portable terminal 5.

The portable reader/writer 200 is a portable reader/writer having the function of performing short-distance radio communication with the portable terminal 5 and, as is the case with the reader/writer section 139, the function of performing near field radio communication with the electronic money card 100.

The portable reader/writer 200 has a slot into which the electronic money card 100 is to be fitted, which allows the user to carry the portable reader/writer 200 and the electronic money card 100 as a single unit in a pocket of the clothes, a bag, or the like.

For communication between the portable reader/writer 200 and the portable terminal 5, for example, Bluetooth is used, but radio conforming to other standards may be used. Bluetooth is a short-distance wireless standard supporting a communication distance which is about a few meters or shorter.

The portable reader/writer 200 saves power consumption by normally being in a standby mode and relays communication between the electronic money card 100 and the portable terminal 5 by being started in response to a request from the portable terminal 5.

Incidentally, in this embodiment, the portable reader/writer 200 and the electronic money card 100 are connected by near field radio communication, but the portable reader/writer 200 and the electronic money card 100 may be connected through wire.

The electronic money card 100 is a card made of resin, the card incorporating an antenna for performing radio communication with the portable reader/writer 200 and an IC module (IC chip) having the functions of storing the value balance, performing information processing which changes the value balance by the balance change information, and controlling radio communication using the antenna.

The electronic money card 100 fitted to the portable reader/writer 200 performs communication with the payment terminal 7 via the portable reader/writer 200, the portable terminal 5, and the reader/writer section 139 and increases or decreases the stored value balance by receiving the balance change information from the payment terminal 7.

As described above, a combination of the portable reader/writer 200 and the electronic money card 100 is formed as a physically integrated unit as a result of fitting into the slot and makes it possible to carry the combination of the portable reader/writer 200 and the electronic money card 100 without difficulty.

In addition, the electronic money card 100 functions as an electronic wallet because the electronic money card 100 allows the value to be withdrawn and deposited (payment and recharging) by performing communication with the payment terminal 7 by radio.

The wireless router 401 is installed in user's home, office, or the like and connects to the Internet 3 through wire and performs radio communication with the portable reader/writer 201 mainly by indoor-type short-distance radio (which is radio that allows communication within a range of about 100 meters from an installation location and may allow communication with the outside).

The configuration of the portable reader/writer 201 is the same as that of the portable reader/writer 200. However, for the portable reader/writer 201, radio of the system that is suitable for Wi-Fi (Wireless Fidelity), for example, is used for connection with the wireless router 401, and settings are made such that the radio distance of the portable reader/writer 201 is longer than that of the portable reader/writer 200.

Therefore, as for radio, the portable reader/writer 201 and the portable reader/writer 200 may be designed separately, or the portable reader/writers 200 and 201 may be formed so as to have the same configuration and selection from two radio systems may be made possible.

When selection of radio systems is made, a radio controller using the two systems is installed in the portable reader/writer 200 (and in the portable reader/writer 201) and selection of radio systems is made by switching of the radio controller.

A set of the portable reader/writer 201 and the electronic money card 101 is kept in, for example, user's home, office, or the like in a manner that allows the set of the portable reader/writer 201 and the electronic money card 101 to be carried around.

The electronic money card 101 and the payment terminal 7 perform communication via the portable reader/writer 201, the wireless router 401, the Internet 3, the relay server 300, the portable terminal 5, and the reader/writer section 139 and perform value balance update processing. Therefore, the electronic money card 101 functions as an electronic wallet which the user can use on the go by using the portable terminal 5.

The wireless router 402 is similar to the wireless router 401 but differs therefrom in that, while the wireless router 401 connects to the Internet 3 through wire, the wireless router 402 connects to the Internet 3 by radio. The wireless router 402 is portable and establishes radio connection with a base station which is installed outside.

Incidentally, in place of this wireless router 402, a smartphone or a tablet terminal having the tethering function also can implement the same function.

The configurations of the portable reader/writer 202 and the electronic money card 102 are the same as those of the portable reader/writers 201 and 200 and the electronic money cards 101 and 100, respectively.

Since a set of the electronic money card 102, the portable reader/writer 202, and the wireless router 402 is portable, the set of the electronic money card 102, the portable reader/writer 202, and the wireless router 402 may be kept in user's home or office or may be taken out of the house or office.

The electronic money card 102 and the payment terminal 7 perform communication via the portable reader/writer 202, the wireless router 402, the Internet 3, the relay server 300, the portable terminal 5, and the reader/writer section 139 and perform value balance update processing. Therefore, the electronic money card 102 functions as an electronic wallet which the user can use on the go by using the portable terminal 5.

Incidentally, when the user carries the set of the electronic money card 102 and the portable reader/writer 202 by taking this set out of the house or office, as is the case with the portable reader/writer 200, the portable reader/writer 202 is provided with the short-distance radio function such that the portable reader/writer 202 and the portable terminal 5 can perform direct communication with each other.

Moreover, in this embodiment, the relay server 300 is installed and the relay server 300 connects to the portable reader/writers 201 and 202, but it is also possible to provide the portable reader/writers 201 and 202 with the function of the relay server 300.

The electronic money cards 100 to 102 and the electronic money storing section 37 (FIG. 6) of the electronic money server 2 function as a plurality of electronic value storage devices that store the balance of electronic value and change the stored balance based on the balance change information.

Furthermore, the payment terminal 7 functions as a balance changing device that transmits the balance change information to the electronic value storage devices.

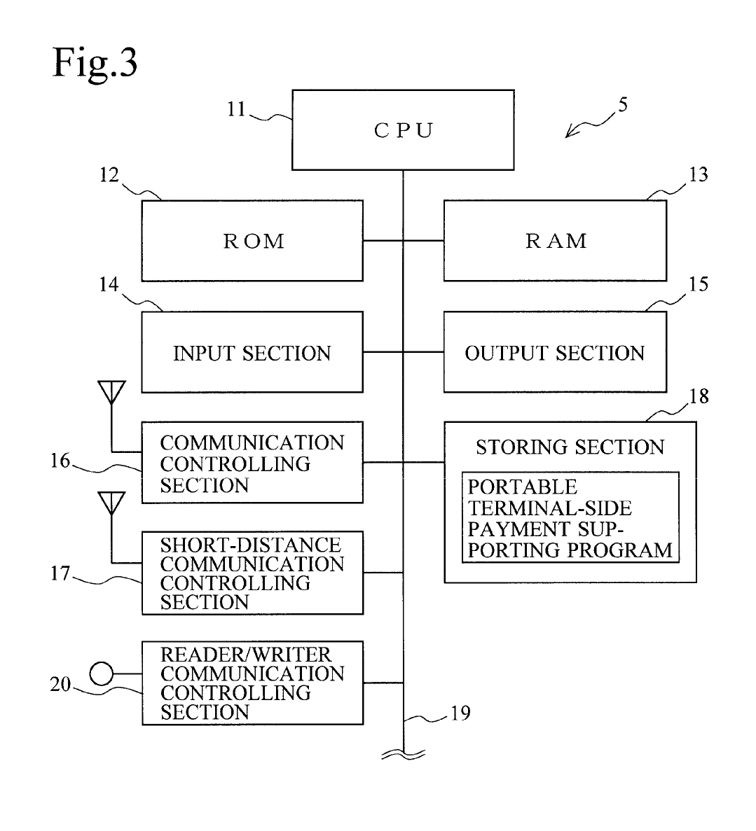

FIG. 3 is a diagram depicting the hardware configuration of the portable terminal 5.

The portable terminal 5 is formed of a CPU (Central Processing Unit) 11, ROM (Read Only Memory) 12, RAM (Random Access Memory) 13, an input section 14, an output section 15, a communication controlling section 16, a short-distance communication controlling section 17, a storing section 18, a reader/writer communication controlling section 20, and so forth which are connected by a bus line 19.

The CPU 11 performs various kinds of information processing and overall control of the portable terminal 5 by executing a program stored in the ROM 12 and the storing section 18. In this embodiment, the CPU 11 executes an application program and thereby supports the function of selecting a device with which connection is to be established (hereinafter, when the electronic money cards 100 to 102 and the electronic money account of the electronic server 2 in which their value balances are to be changed are not differentiated from one another, they are collectively called a device with which connection is to be established) and payment performed by the device with which connection is to be established and recharging performed on the device with which connection is to be established by relaying communication between the selected device with which connection is to be established and the payment terminal 7.

The ROM 12 is read-only memory, and a basic program used by the portable terminal 5 to operate, a parameter, data, and so forth are stored therein.

The RAM 13 is readable/writable memory and offers working memory used when the CPU 11 performs information processing.

The input section 14 is a functional section that inputs information from the outside and is formed of, for example, input devices such as a touch panel installed on a liquid crystal display, a microphone, and an acceleration sensor.

When the user touches an icon or a keyboard displayed on the liquid crystal display, the touch panel senses it and input is performed.

From the microphone, the voice of the user is input. From the acceleration sensor, the direction and magnitude of acceleration are input, which allows the user to input information by shaking the portable terminal 5, for example.

The output section 15 is a functional section that outputs information to the user and is formed of, for example, output devices such as a liquid crystal display for screen display, a speaker from which sound is output, and a vibrator that makes the user feel vibrations.

In this embodiment, the output section 15 performs screen display by an application and displays, for example, a startup screen that starts an application, an operation screen that displays the operation status of the application, a pairing screen that is displayed when the portable terminal 5 is paired with the device with which connection is to be established, and so forth.

The storing section 18 is formed by using, for example, storage media such as an EEPROM (Electrically Erasable and Programmable ROM) and a hard disk, and an OS (Operating System) which is a basic program that controls the portable terminal 5, an application program, and other programs and data are stored therein.

The communication controlling section 16 includes an antenna for performing radio communication with a base station antenna of a mobile telephone network and connects the portable terminal 5 to the Internet 3 or a telephone line.

The short-distance communication controlling section 17 includes an antenna for short-distance radio communication and performs short-distance radio communication such as Bluetooth.

The reader/writer communication controlling section 20 includes an antenna for performing radio communication with the reader/writer section 139 and performs near field radio communication with the reader/writer section 139. The reader/writer communication controlling section 20 can also perform near field radio communication with the electronic money cards 100 to 102.

As described above, the portable terminal 5 includes a selecting unit that selects one of the plurality of electronic value storage devices, each changing the stored balance based on the balance change information, in order to select a target device with which connection is to be established from the plurality of devices with which connection is to be established, the plurality of devices functioning as the electronic value storage devices.

Moreover, the antennas of the communication controlling section 16 and the short-distance communication controlling section 17 function as a first antenna, and the portable terminal 5 includes a first radio connecting unit that connects to the selected electronic value storage device via radio communication using the first antenna in order to establish radio connection with the device with which connection is to be established by using the antenna.

Furthermore, the antenna of the reader/writer communication controlling section 20 functions as a second antenna, and the portable terminal 5 includes a second radio connecting unit that connects, via radio communication using the second antenna, to the balance changing device that transmits the balance change information to the electronic value storage device in order to establish radio connection with the payment terminal 7 functioning as the balance changing device.

In addition, the portable terminal 5 includes a relaying unit that relays communication between the electronic value storage device to which the portable terminal 5 connects and the balance changing device to which the portable terminal 5 connects in order to relay communication between the device with which connection is to be established and the payment terminal 7 with which radio connection is established.

Incidentally, the portable terminal 5 itself may have a built-in IC module or an IC module attached thereto. As a result of the portable terminal 5 having a built-in IC module or an IC module attached thereto, it is possible to perform electronic money payment processing by using the portable terminal 5 itself.

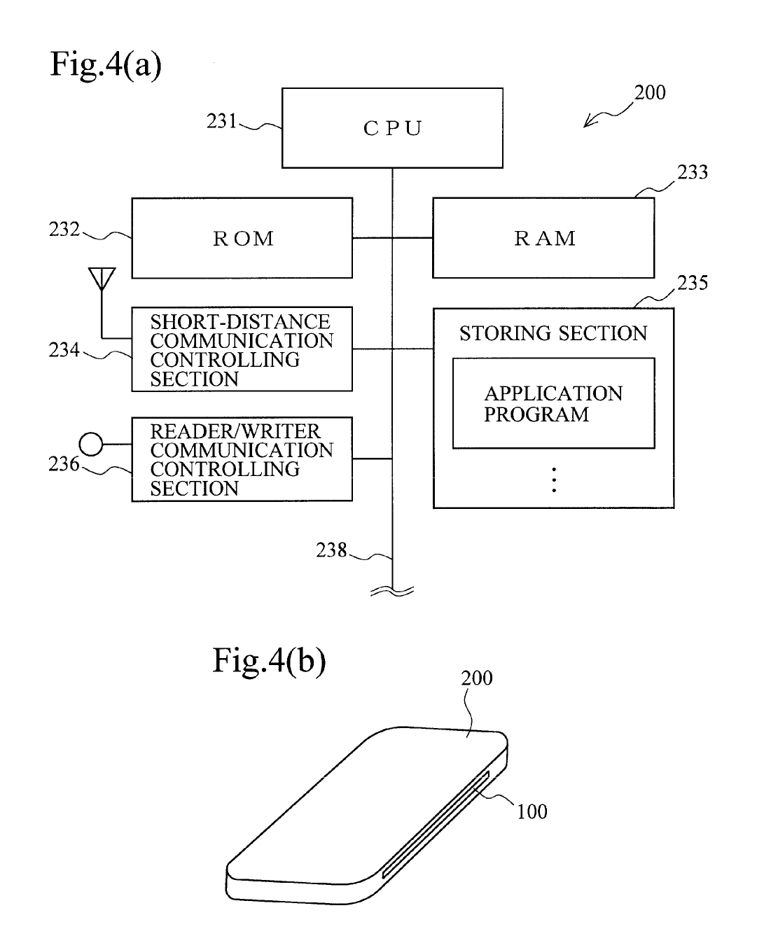

FIG. 4(a) is a diagram depicting the hardware configuration of the portable reader/writer 200.

The portable reader/writer 200 is formed of a CPU 231, ROM 232, RAM 233, a short-distance communication controlling section 234, a storing section 235, a reader/writer communication controlling section 236, and so forth which are connected by a bus line 238.

The CPU 231 performs various kinds of information processing and overall control of the portable reader/writer 200 by executing a program stored in the ROM 232 and the storing section 235.

The ROM 232 is read-only memory, and a basic program used by the portable reader/writer 200 to operate, a parameter, data, and so forth are stored therein.

The RAM 233 is readable/writable memory and offers working memory used when the CPU 231 performs information processing.

The storing section 235 is formed by using, for example, a nonvolatile storage medium such as an EEPROM, and an OS (Operating System) which is a basic program that controls the portable reader/writer 200, a portable reader/writer program, and other programs and data are stored therein.

As a result of the portable reader/writer program being executed by the CPU 231, the portable reader/writer 200 is normally in the standby mode and, when receiving a startup request from the portable terminal 5, the portable reader/writer 200 starts and relays communication between the electronic money card 100 and the electronic money server 2.

The short-distance communication controlling section 234 includes an antenna for short-distance radio communication and performs, for example, short-distance radio communication with the portable terminal 5 by Bluetooth, for example.

The reader/writer communication controlling section 236 includes an antenna for performing near field radio communication and performs near field radio communication with the electronic money card 100. As the reader/writer communication controlling section 236, for example, a radio communication circuit such as a wireless LAN chip can be used.

FIG. 4(b) is a diagram depicting the appearance of the portable reader/writer 200.

The portable reader/writer 200 is a plate-like device of a size that allows the portable reader/writer 200 to be held in one hand, and a slot in which the electronic money card 100 is to be housed is formed in a side face thereof.

When the electronic money card 100 is housed in this slot, a portable electronic money device with radio function into which the portable reader/writer 200 and the electronic money card 100 are integrated is formed.

Incidentally, even in a state in which the electronic money card 100 is fitted to this portable reader/writer 200, normal payment processing can be performed between the electronic money card 100 and the payment terminal 7 without a hitch. Thus, there is no need to take the electronic money card 100 out of the portable reader/writer 200 every time payment is performed.

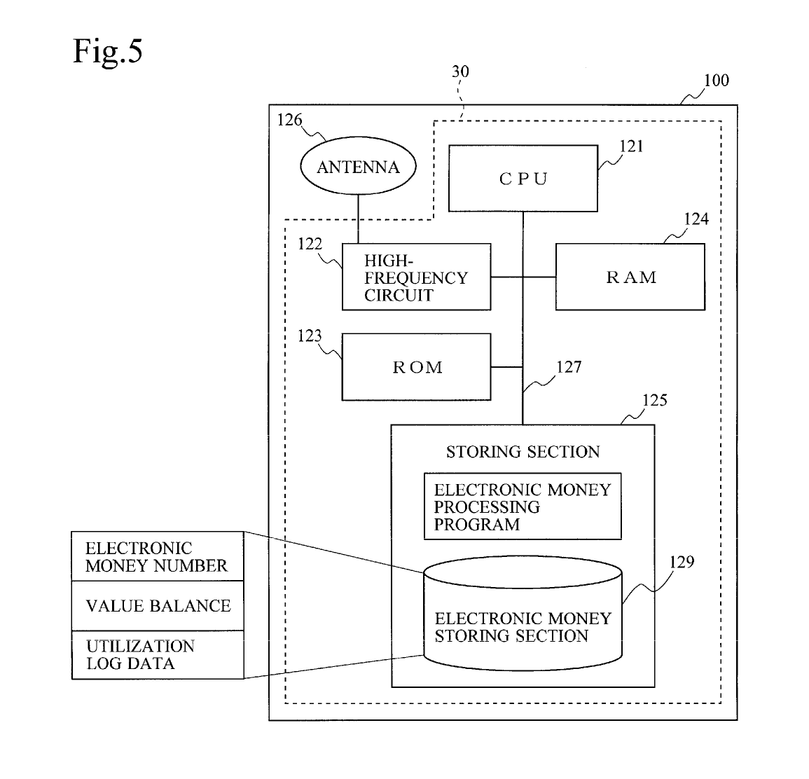

FIG. 5 is a diagram depicting the hardware configuration of the electronic money card 100.

The electronic money card 100 is formed of an IC module 30 formed of a CPU 121, ROM 123, RAM 124, a high-frequency circuit 122, a storing section 125, and so forth which are connected by a bus line 127 and an antenna 126 for performing near field radio communication by a reader/writer section, the IC module 30 and the antenna 126 embedded in a card made of resin.

The CPU 121 performs various kinds of information processing and overall control of the IC module 30 by executing a program stored in the ROM 123 and the storing section 125.

The ROM 123 is read-only memory, and a basic program used by the IC module 30 to operate, a parameter, data, and so forth are stored therein.

The RAM 124 is readable/writable memory and offers working memory used when the CPU 121 performs information processing.

The high-frequency circuit 122 drives the antenna 126 and performs near field radio communication with reader/writers such as the portable reader/writer 200 and the reader/writer section 139.

The storing section 125 is formed by using, for example, a nonvolatile storage medium such as an EEPROM, and, in addition to an OS (Operating System) which is a basic program that controls the IC module 30 and an electronic money processing program, authentication information, an electronic money storing section 129, and so forth are stored therein.

By executing the electronic money processing program by the CPU 121, the IC module 30 can increase or decrease the value balance stored in the electronic money storing section 129 by using the balance change information, record utilization log data, and perform various kinds of information processing related to electronic money.

The electronic money storing section 129 stores an electronic money number, a value balance, utilization log data, and so forth.

The electronic money number is a number unique to the electronic money storing section 129, and the electronic money system 1 identifies the electronic money storing section 129 by the electronic money number.

The value balance is the total amount of value which is currently stored, and payment is performed by using the value balance.

The utilization log data is utilization log data which is the record of the date and time on and at which the IC module 30 performed processing related to electronic money, the details of the processing, and so forth and a predetermined number of data is recorded. When the number of utilization log data exceeds the predetermined number of data, data is deleted in order, oldest first. Therefore, there is no possibility that the storing section 125 is cluttered with the utilization log data.

FIG. 6 is a diagram depicting the hardware configuration of the electronic money server 2.

The electronic money server 2 is formed of a CPU 31, ROM 32, RAM 33, a communication controlling section 34, a storing section 35, and so forth which are connected by a bus line 36.

The CPU 31 performs various kinds of information processing and overall control of the electronic money server 2 by executing a program stored in the ROM 32 and the storing section 35.

The ROM 32 is read-only memory, and a basic program used by the electronic money server 2 to operate, a parameter, data, and so forth are stored therein.

The RAM 33 is readable/writable memory and offers working memory used when the CPU 31 performs information processing.

The communication controlling section 34 controls communication which the electronic money server 2 performs via the Internet 3.

The storing section 35 is formed by using, for example, a large-capacity storage medium such as a hard disk, and an OS (Operating System) which is a basic program that controls the electronic money server 2, a server-side payment supporting program, the electronic money storing section 37, and so forth are stored therein.

By executing the server-side payment supporting program by the CPU 31, the electronic money server 2 can increase or decrease the value balance by using the balance change information, record utilization log data, and perform various kinds of information processing related to electronic money.

The electronic money storing section 37 stores a plurality of pieces of account information of an electronic money account, such as an electronic money number, a value balance, and utilization log data.

The electronic money number is an account number unique to the electronic money storing section 37, and the electronic money system 1 identifies the electronic money account in the electronic money storing section 37 by the electronic money number.

The value balance is the monetary value of value, and payment is performed by using the value balance.

The utilization log data is utilization log data which is the record of the date and time on and at which the electronic money server 2 performed processing related to electronic money of the account, the details of the processing, and so forth.

The electronic money server 2 receives the electronic money number from the portable terminal 5, identifies the electronic money account to be processed in the electronic money storing section 37, then receives the balance change information from the portable terminal 5, and increases or decreases the value balance of the identified electronic money account in accordance with the balance change information.

Incidentally, though not depicted in the drawing, the configuration of the relay server 300 is similar to the configuration of the electronic money server 2. When receiving a request from the portable terminal 5, the relay server 300 starts the portable reader/writer 201 which is in the standby mode and relays communication performed by the portable reader/writer 201.

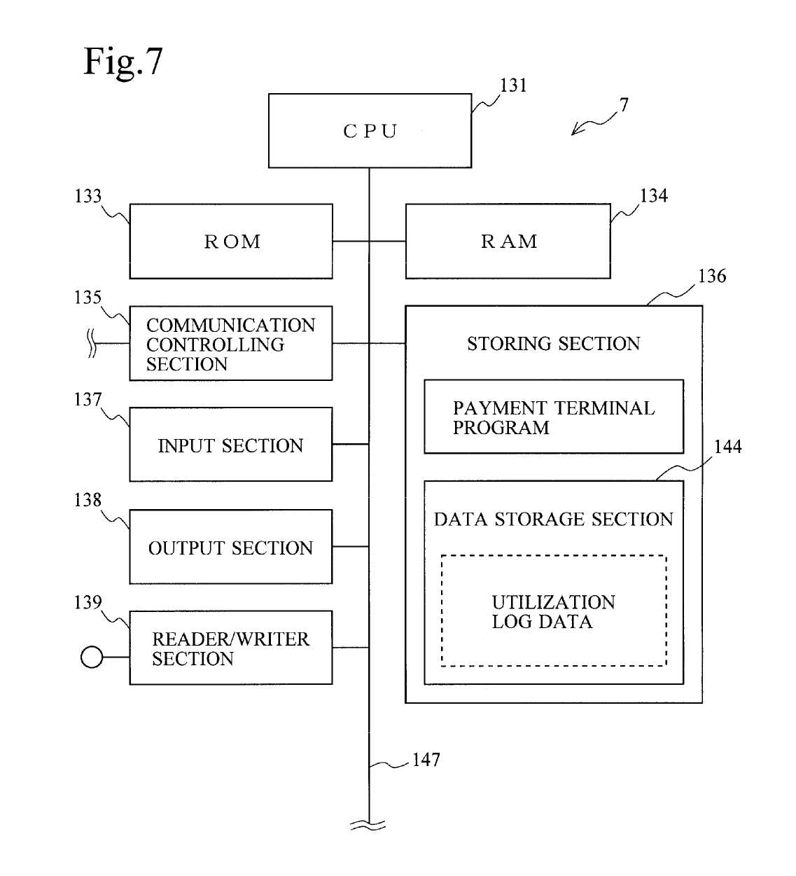

FIG. 7 is a diagram depicting the hardware configuration of the payment terminal 7.

The payment terminal 7 is formed of a CPU 131, ROM 133, RAM 134, a communication controlling section 135, a storing section 136, an input section 137, an output section 138, the reader/writer section 139, and so forth which are connected by a bus line 147.

The CPU 131 performs various kinds of information processing and overall control of the payment terminal 7 by executing a program stored in the ROM 133 and the storing section 136.

The ROM 133 is read-only memory, and a basic program used by the payment terminal 7 to operate, a parameter, data, and so forth are stored therein.

The RAM 134 is readable/writable memory and offers working memory used when the CPU 131 performs information processing.

The communication controlling section 135 controls communication which the payment terminal 7 performs via the Internet 3.

The input section 137 includes, for example, input devices such as a bar code and a bar code reader and allows a person in charge to input a product code, a payment amount, a recharging amount, and so forth.

The output section 138 is connected to a display device using a liquid crystal display or the like, a printer, a speaker, and so forth and presents information to a customer and a person in charge of the store.

The reader/writer section 139 includes the placement surface on which an object with which communication is to be performed is put and an antenna for near field radio communication, the antenna disposed below the placement surface, and performs near field radio communication with the portable terminal 5 or the like which is put on the placement surface.

The storing section 136 is formed by using, for example, storage media such as semiconductor storage and a hard disk, and, in addition to an OS (Operating System) which is a basic program that controls the payment terminal 7 and a payment terminal program, a data storage section 144 and so forth are stored therein. In the data storage section 144, for example, utilization log data is stored.

By executing the payment terminal program by the CPU 131, the payment terminal 7 can perform payment and recharging by performing communication with the electronic money card 100 or the like via the portable terminal 5 and transmitting the balance change information.

Incidentally, also when the electronic money card 100 is put on the placement surface or the portable reader/writer 200 to which the electronic money card is fitted is put on the placement surface, the reader/writer section 139 can perform communication with the electronic money card 100. In this case, the electronic money card 100 can perform recharging and payment by performing communication directly with the payment terminal 7 without the portable terminal 5.

Next, the operation of the electronic money system 1 configured as described above will be described.

Prior to the use of the electronic money system 1, the user makes various settings by using the portable terminal 5. These settings can be performed from a setting menu which is displayed on a display as a result an application being executed on the portable terminal 5.

First, the user registers, on the portable terminal 5, an electronic money account, the electronic money card 100, and so forth which are devices with which connection is to be established. By not performing processing related to value with an unregistered device with which connection is to be established, it is possible to improve security.

In this case, the relaying unit of the portable terminal 5 does not relay communication of the balance changing device that has not been registered in advance.

When the electronic money account is registered, the portable terminal 5 is connected to the electronic money server 2, and the electronic money number for the electronic money account of the user is transmitted to the electronic money server 2 from the portable terminal 5.

Then, after the electronic money server 2 performs user authentication and device authentication of the portable terminal 5 and the portable terminal 5 performs device authentication of the electronic money server 2 (that is, mutual authentication is performed), the portable terminal 5 and the electronic money server 2 set the electronic money server 2 and the portable terminal 5, respectively, as a device with which communication is to be performed.

On the other hand, when the electronic money card 100 is registered, registration is performed as follows: after the portable terminal 5 is connected to the electronic money card 100 and authentication is performed, the portable terminal 5 stores the electronic money number of the electronic money card 100. The settings of the electronic money card 101 and the electronic money card 102 are performed in the same manner.

Incidentally, bringing the portable terminal 5 closer to the electronic money card 100 and making the portable terminal and the electronic money card 100 perform mutual authentication and settings by using the reader/writer communication controlling section 20 of the portable terminal 5 can further improve security because this makes the user perform pairing while holding the two devices in his/her hands.

As described above, if the electronic value storage device is a portable device (a device that can be held in one hand), a registering unit of the portable terminal 5 performs registration when the registering unit authenticates this electronic value storage device by using near field radio communication.

Moreover, by adopting a configuration in which the portable reader/writer 200 is provided with a device authentication function, the portable terminal 5 and the portable reader/writer 200 authenticate each other, and a set of the electronic money card 100 and the portable reader/writer 200 is registered on the portable terminal 5, it is possible to further improve security.

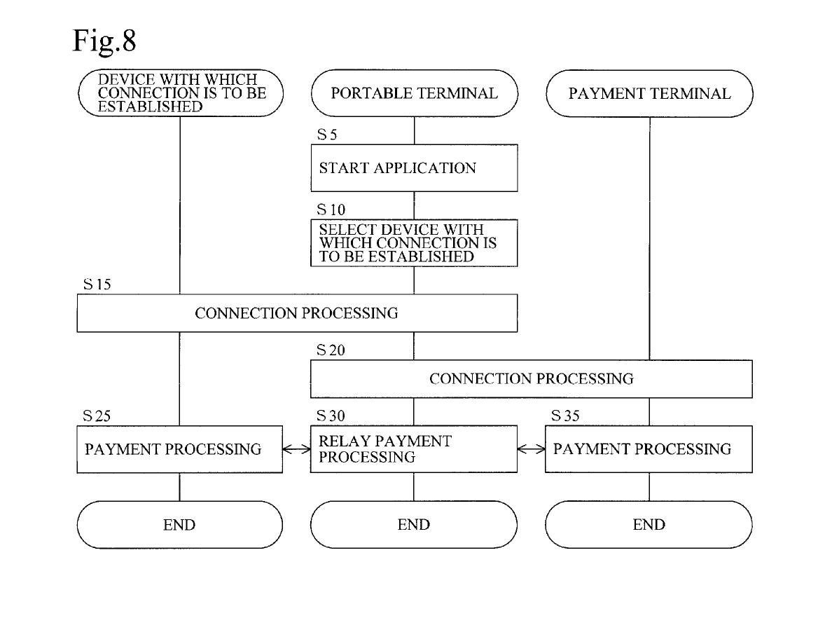

FIG. 8 is a flowchart for explaining the overall operation of payment processing using the electronic money system 1.

In the drawing, a device with which connection is to be established is a device registered on the portable terminal 5 and having the electronic money processing function and, here, one of the electronic money server 2 and the electronic money cards 100 to 102.

First, the user starts an application by executing the application program by, for example, touching an icon displayed on the liquid crystal display (Step 5). The following functions are implemented by this application.

Next, the portable terminal 5 selects a device with which connection is to be established (Step 10).

As for this selection, for example, a list of the devices with which connection is to be established is displayed on the display of the portable terminal 5 and the user makes selection every time the user makes payment.

Incidentally, as selection of a device with which connection is to be established, there are various modified examples. For example, a configuration can be adopted in which the user assigns, in advance, priorities to the devices with which connection is to be established and makes the portable terminal 5 stores the priorities and the portable terminal 5 automatically selects a device with which connection is to be established, the device of high priority.

In this case, based on a predetermined order, the selecting unit of the portable terminal 5 selects an electronic value storage device with which payment can be performed.

Moreover, the speed of communication with a device with which connection is to be established differs depending on the network environment. Thus, a configuration can also be adopted in which the portable terminal 5 measures the speed of communication with each device with which connection is to be established and automatically assigns priorities in descending or ascending order of communication speed.

In this case, the predetermined order is the order of speed of communication by the first radio connecting unit.

Moreover, if a fast processing speed is required in, for example, a reader/writer section set in a gate of a railroad, a device with which connection is to be established may be dynamically selected depending on the situation, such as selecting a device with which connection is to be established, the device with a fast communication speed. In this case, the reader/writer section outputs a signal based on which a determination as to whether a fast processing speed is required or not is made, and the portable terminal 5 makes a determination by using this signal.

In this case, the portable terminal 5 includes a condition receiving unit that receives a condition under which priorities are assigned from the balance changing device (such as the reader/writer section set in the gate) with which connection is established by the second radio connecting unit, and the predetermined order is an order conforming to the received condition.

Furthermore, the availability (ease of connection by a communication network) of a device with which connection is to be established differs depending on the network environment. Thus, by assigning priorities in ascending order of availability, since a device with which connection is to be established, the device with lower availability, is first used, it is possible to set aside a device with which connection is to be established, the device with higher availability, for later use.

Priorities based on availability may be assigned manually or the portable terminal 5 may automatically assign priorities by determining availability by counting the occurrence of trouble, for example.

In this case, the predetermined order is an ascending order of availability by the first radio connecting unit.

After selecting the device with which connection is to be established in this manner, the portable terminal 5 performs connection processing to connect to the device with which connection is to be established (Step 15).

Next, the portable terminal 5 performs connection processing to connect to the payment terminal 7 by, for example, being put on the placement surface of the reader/writer section 139 (Step 20).

As described above, by performing connection processing to connect to the device with which connection is to be established promptly before connection with the payment terminal 7 is established after the application is started, the time that elapses before the user puts the portable terminal 5 on the reader/writer section 139 can be used effectively for connection with the device with which connection is to be established, which makes it possible to perform payment processing promptly.

When connection with the payment terminal 7 is established, the portable terminal 5 starts relaying between the device with which connection is to be established and the payment terminal 7.

Then, the device with which connection is to be established and the payment terminal 7 perform payment processing (Steps 25 and 35), and the portable terminal 5 relays this payment processing (Step 30).

When the payment processing is completed, the payment terminal 7 provides a notification to the user by sound or the like.

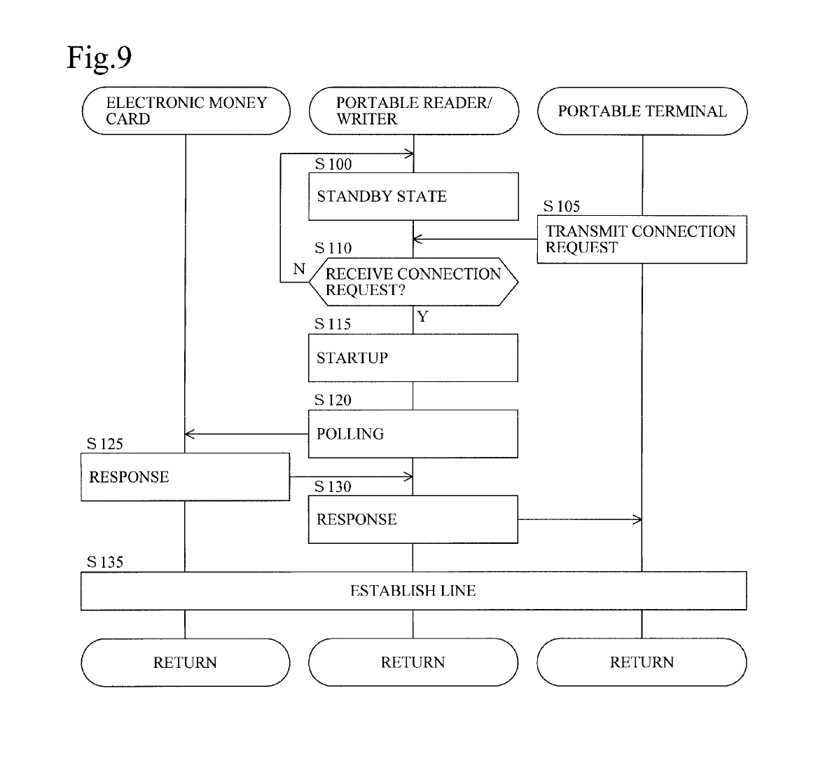

FIG. 9 is, in Step 15, a flowchart for explaining the procedures of connection processing when the electronic money card 100 is used as the device with which connection is to be established.

First, the portable reader/writer 200 is in a standby state (Step 100). In addition, the portable reader/writer 200 monitors whether or not a connection request is received (Step 110). By being in the standby state, the portable reader/writer 200 reduces the exhaustion of a battery.

If a connection request is not received (Step 110; N), the portable reader/writer 200 maintains the standby state.

On the other hand, when the application selects the electronic money card 100, the portable terminal 5 transmits a connection request to the portable reader/writer 200 (Step 105).

Then, the portable reader/writer 200 receives the connection request in Step 110 (Step 110; Y) and transitions from the standby state to a startup state (Step 115).

When the portable reader/writer 200 is started, the portable reader/writer 200 performs polling on the electronic money card 100 fitted into the slot (Step 120).

In response thereto, the electronic money card 100 gives a response to the portable reader/writer 200 (Step 125).

When receiving the response from the electronic money card 100, the portable reader/writer 200 gives a response to the portable terminal 5 (Step 130), and the portable terminal 5 establishes a connection line between the portable terminal 5 and the electronic money card 100 (Step 135).

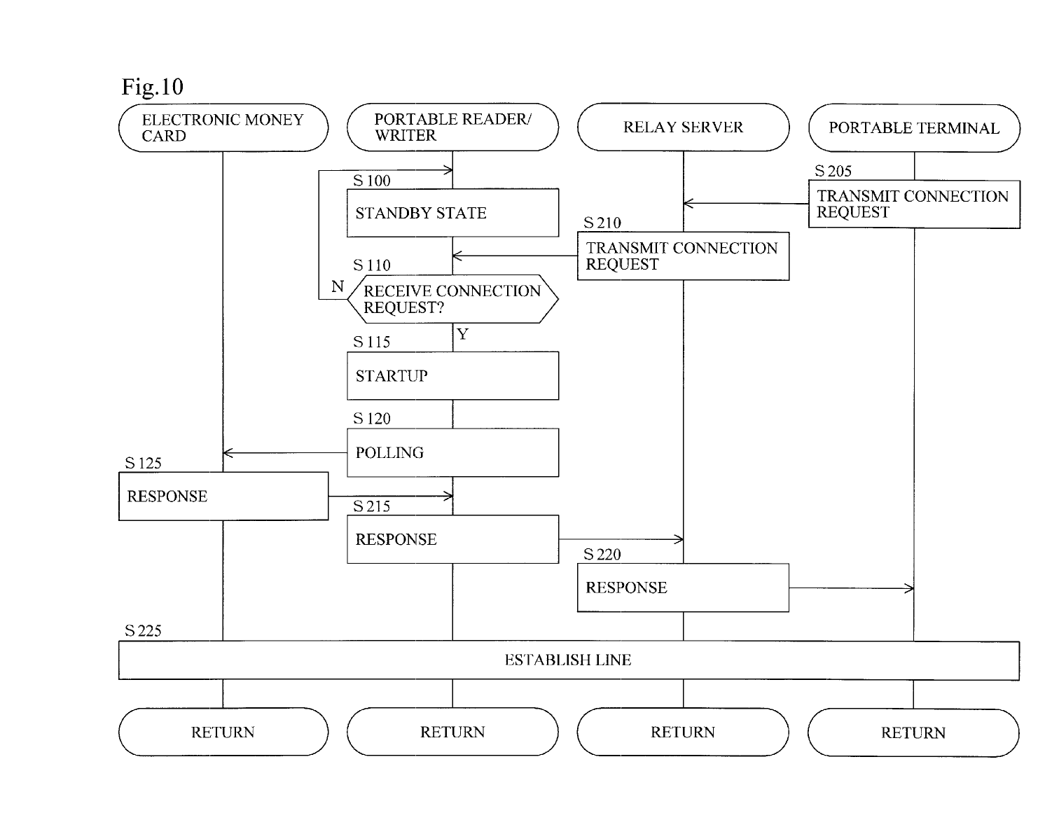

FIG. 10 is, in Step 15, a flowchart for explaining the procedures of connection processing when the electronic money card 101 is used as the device with which connection is to be established. The same processing as the processing in FIG. 9 is identified with the same step number and the explanation thereof is simplified or omitted.

First, the portable terminal 5 transmits a connection request to the relay server 300 (Step 205).

On the relay server 300, the electronic money cards 101 and 102 which are devices with which connection is to be established by the portable terminal 5 are registered, and the connection request is accompanied with information for identifying an electronic money card with which connection is to be established.

When receiving the connection request from the portable terminal 5, the relay server 300 transmits a connection request to the portable reader/writer 201 (accesses the portable reader/writer 201) via the wireless router 401 (Step 210).

The portable reader/writer 201 connects to the electronic money card 101 by being started by using the access from the relay server 300 as a trigger (Steps 115 to 125), and the portable reader/writer 201 gives a response to the relay server 300 (Step 215).

When receiving the response from the portable reader/writer 201, the relay server 300 gives a response to the portable terminal 5 (Step 220) and provides a notification that a communication line between the relay server 300 and the electronic money card 101 has been established.

When receiving the response from the relay server 300, the portable terminal 5 establishes a communication line between the portable terminal 5 and the electronic money card 101 (Step 225).

The same goes for a case where the portable terminal 5 connects to the electronic money card 102 via the relay server 300, the wireless router 402, and the portable reader/writer 202.

When the portable terminal 5 connects to the electronic money server 2, the portable terminal 5 transmits the electronic money number of the electronic money account of the user to the electronic money server 2, and the electronic money server 2 identifies the electronic money account with which payment is to be performed based on the electronic money number and gives a response to the portable terminal 5.

Then, the portable terminal 5 and the electronic money server 2 establish a communication line.

Next, the connection processing in Step 20 will be described.

The payment terminal 7 detects that the portable terminal 5 is placed on the placement surface of the reader/writer section 139 based on the radio waves emitted from the portable terminal 5 and performs polling on the portable terminal 5. In response thereto, the portable terminal 5 gives a response, and the payment terminal 7 and the portable terminal 5 establish a communication line.

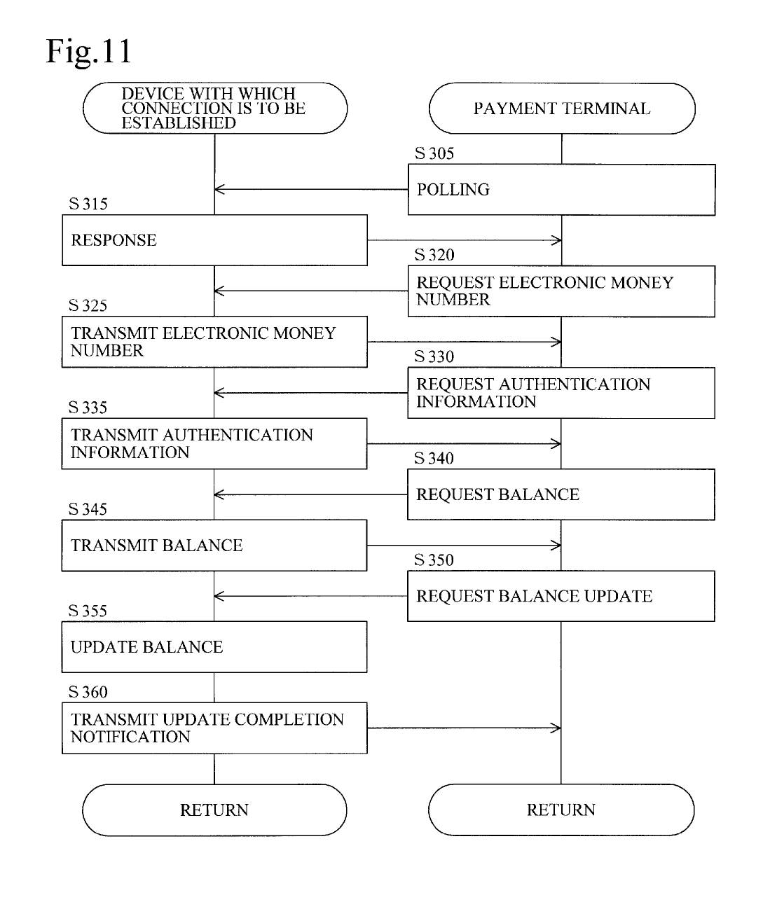

FIG. 11 is a flowchart for explaining the procedures of the payment processing in Steps 25 and 35.

First, the payment terminal 7 performs polling on the device with which connection is to be established (Step 305).

When being subjected to polling, the device with which connection is to be established gives a response to the payment terminal 7 (Step 315).

When receiving the response from the device with which connection is to be established, the payment terminal 7 requests an electronic money number from the device with which connection is to be established (Step 320).

In response to this request, the device with which connection is to be established transmits the electronic money number (Step 325).

More specifically, if the device with which connection is to be established is the electronic money card 100 (the same goes for the electronic money cards 101 and 102), the electronic money card 100 reads the electronic money number from the electronic money storing section 129 and transmits the read electronic money number; if the device with which connection is to be established is the electronic money server 2, the electronic money server 2 reads the electronic money number of the electronic money account of the user from the electronic money storing section 37 and transmits the read electronic money number.

Next, the payment terminal 7 requests authentication information from the device with which connection is to be established (Step 330), and, in response thereto, the device with which connection is to be established transmits the authentication information to the payment terminal 7 (Step 335).

After the payment terminal 7 receives the authentication information from the device with which connection is to be established and authenticates the authentication information, the payment terminal 7 requests a notification of the value balance from the device with which connection is to be established (Step 340).

In response to this request, the device with which connection is to be established reads the amount of the value balance and transmits the value balance to the payment terminal 7 (Step 345).

The payment terminal 7 checks the value balance transmitted from the device with which connection is to be established, and, if the value balance is less than the payment amount, the payment terminal 7 notifies the person in charge of the store of a shortage of the balance by using display or sound.

If payment can be performed by the value balance, the payment terminal 7 requests a balance update by generating balance change information to the effect that the value balance is reduced by the payment amount and transmitting the balance change information to the device with which connection is to be established (Step 350).

Here, the balance change information may be a subtraction command by which the payment amount is subtracted from the value balance or an overwriting command by which the payment terminal 7 calculates a balance after payment and the value balance is overwritten with the balance after payment. The same goes for recharging.

The device with which connection is to be established receives the balance change information from the payment terminal 7 and updates the value balance to the amount after payment by using the balance change information (Step 355).

Then, the device with which connection is to be established transmits an update completion notification to the payment terminal 7 (Step 360). This is the end of the payment processing.

Next, modified examples will be described.

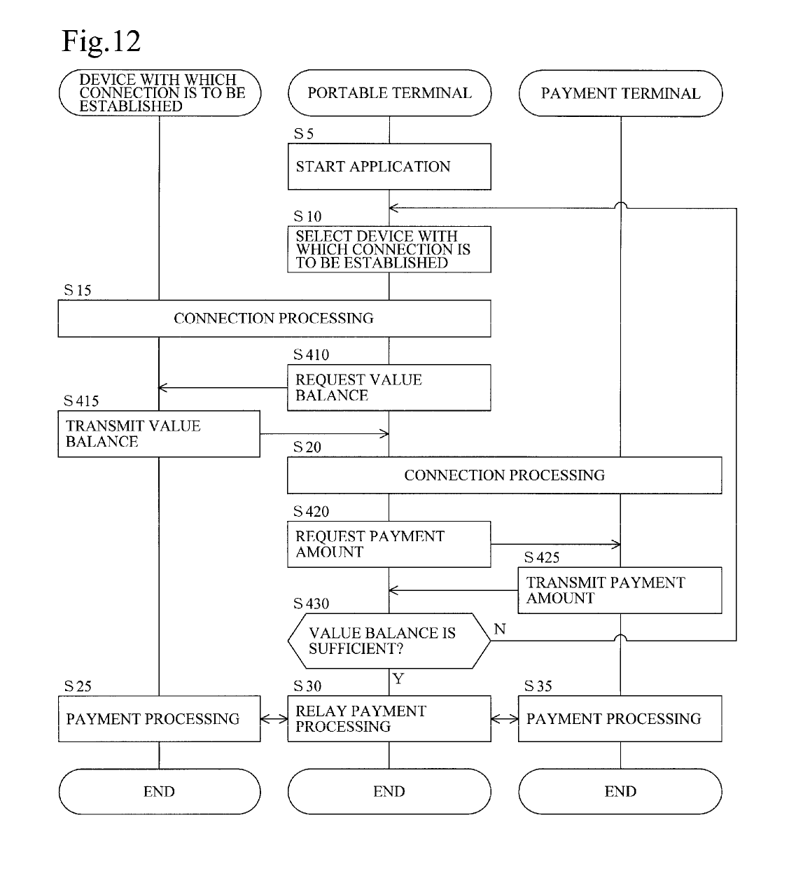

FIG. 12 is a flowchart for explaining a first modified example.

In this example, the portable terminal 5 searches for a device with which connection is to be established, the device with which payment can be performed, by the priorities of the devices with which connection is to be established.

The same steps as those of FIG. 8 are identified with the same step numbers and the explanations thereof are simplified or omitted.

After the portable terminal 5 performs connection processing with the device with which connection is to be established (Step 15), the portable terminal 5 requests a notification of the value balance from the device with which connection is to be established (Step 410).

In response thereto, the device with which connection is to be established reads the amount of the value balance and transmits the value balance to the portable terminal 5 (Step 415).

Then, after the portable terminal 5 connects to the payment terminal 7 (Step 20), the portable terminal 5 requests the payment amount from the payment terminal 7 (Step 420).

In response thereto, the payment terminal 7 transmits the payment amount to the portable terminal 5 (Step 425).

When receiving the payment amount from the payment terminal 7, the portable terminal 5 compares the payment amount with the value balance received from the device with which connection is to be established and determines whether or not the value balance is sufficient (Step 430).

If the value balance is sufficient (Step 430; Y), the portable terminal 5 transitions to relaying of payment processing between the device with which connection is to be established and the payment terminal 7 (Step 30).

On the other hand, if the value balance is not sufficient (Step 430; N), the portable terminal 5 goes back to Step 10 and selects a device with which connection is to be established, the device of second highest priority.

Then, the portable terminal 5 continues the same processing until the portable terminal 5 finds a device with which connection is to be established, the device with a sufficient value balance. If the value balances of all the devices with which connection is to be established are insufficient, the portable terminal 5 transmits an error message to the payment terminal 7 and ends the processing.

In the above description, the portable terminal 5 selects a device with which connection is to be established, the device which is to be used for payment, after receiving the payment amount from the payment terminal 7, but the processing time can be saved by acquiring in advance the value balance from all the registered devices with which connection is to be established and temporarily storing the value balances in the RAM 13 or the like before receiving the payment amount from the payment terminal 7 and immediately selecting a device with which connection is to be established, the device with which connection should be established, based on the temporarily stored value balances of the devices with which connection is to be established when receiving the payment amount from the payment terminal 7.

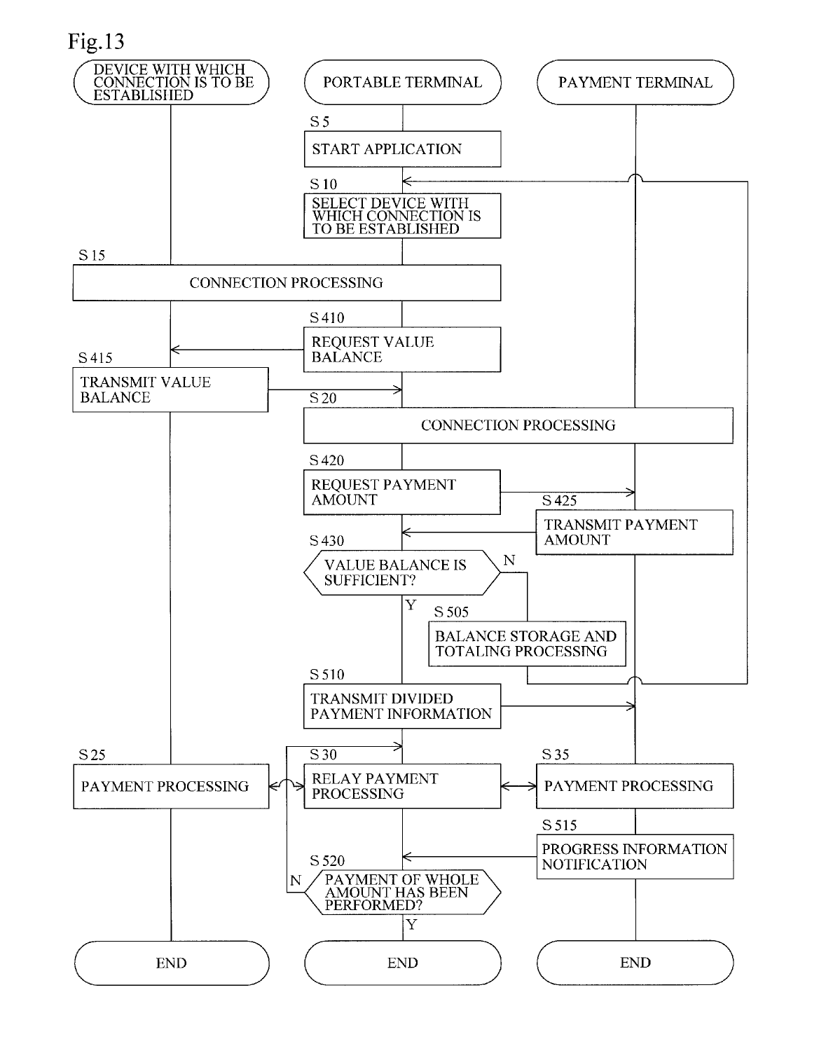

FIG. 13 is a flowchart for explaining a second modified example.

In this example, when the value balance of a device with which connection is to be established is insufficient, the portable terminal 5 performs payment in order from a device with which connection is to be established, the device of highest priority, such that the total amount becomes equal to the payment amount.

The same steps as those of FIG. 12 are identified with the same step numbers and the explanations thereof are simplified or omitted.

The portable terminal 5 connects a device with which connection is to be established, the device of highest priority, and the payment terminal 7, receives the value balance from the device with which connection is to be established, and, after receiving the payment amount from the payment terminal 7, determines whether or not the value balance is sufficient for the payment amount (Steps 5 to 430).

If the value balance is not sufficient (Step 430; N), the portable terminal 5 stores a combination of the device with which connection is to be established and the value balance and the total amount of the value balance (the value balance of the device with which connection is to be established in the first loop, and, in the second and following loops, the newly acquired value balance is added thereto and the total thereof is calculated) (Step 505), and goes back to Step 10.

Then, the portable terminal 5 selects a device with which connection is to be established, the device of second highest priority (Step 10), and the portable terminal 5 then repeatedly performs a loop of Steps 10 to 505 until the total amount in Step 505 exceeds the payment amount and searches for a device with which connection is to be established, the device with which payment is to be performed.

If the total amount of the value balances of all the registered devices with which connection is to be established is less than the payment amount, the portable terminal 5 transmits an error message to the payment terminal 7 and ends the processing.

If the total amount of the value balances exceeds the payment amount (Step 430; Y), for the devices with which connection is to be established on which a search has been performed in the above loop, the portable terminal 5 determines a divided payment amount for each of the devices with which connection is to be established such that the total value becomes equal to the payment amount.

For example, the portable terminal 5 allocates the whole of the value balance to payment from a device with which connection is to be established, the device of highest priority, and uses the value balance of the last device with which connection is to be established to make payment of an odd amount.

Then, the portable terminal 5 transmits divided payment information formed of the number of divisions and the divided payment amount of each division to the payment terminal 7 (Step 510).

For example, when payment of 500 yen is performed by performing payment of 200 yen by the first device with which connection is to be established, payment of 250 yen by the next device with which connection is to be established, and payment of 50 yen by the last device with which connection is to be established, the divided payment information is (200, 250, 50). As described above, the divided payment information notifies the payment terminal 7 of the schedule of divided payment.

Then, the portable terminal 5 relays payment processing between the first device with which connection is to be established and the payment terminal 7 (Step 30), and the first device with which connection is to be established and the payment terminal 7 perform first divided payment (Step 25, Step 35).

When the divided payment is completed, the payment terminal 7 outputs a divided payment completion signal. The portable terminal 5 monitors the contents of communication while relaying communication between the device with which connection is to be established and the payment terminal 7.

The portable terminal 5 cannot understand the communication between the device with which connection is to be established and the payment terminal 7 because the communication is encrypted, but the divided payment completion signal is output from the payment terminal 7 as a signal which the portable terminal 5 can understand. Moreover, since the device with which connection is to be established cannot understand the divided payment completion signal, the divided payment completion signal is ignored by the device with which connection is to be established.

Alternatively, the portable terminal 5 may sense the completion of divided payment by detecting that the communication between the device with which connection is to be established and the payment terminal 7 ceases due to the completion of the divided payment processing.

When receiving the divided payment completion signal which is a progress information notification (Step 515), the portable terminal 5 determines whether or not payment of the whole amount has been performed (that is, payment has been performed by all the searched devices with which connection is to be established) (Step 520).

If payment of the whole amount has not been performed yet (Step 520; N), the portable terminal 5 redirects connection to the next device with which connection is to be established in accordance with the schedule of divided payment and relays payment processing between the next device with which connection is to be established and the payment terminal 7 (Step 30), and the next device with which connection is to be established and the payment terminal 7 perform next divided payment (Step 25, Step 35).

In this way, the portable terminal 5 can perform divided payment by sequentially switching a device with which connection is to be established, the device on which relaying is to be performed, to another device with which connection is to be established.

In the above description, the portable terminal 5 searches for a device with which connection is to be established, the device which is to be used for payment, after receiving the payment amount from the payment terminal 7, but the processing time can be saved by acquiring in advance the value balance from all the registered devices with which connection is to be established and temporarily storing the value balances in the RAM 13 or the like before receiving the payment amount from the payment terminal 7 and immediately creating a division schedule based on the temporarily stored value balances of the devices with which connection is to be established when receiving the payment amount from the payment terminal 7.

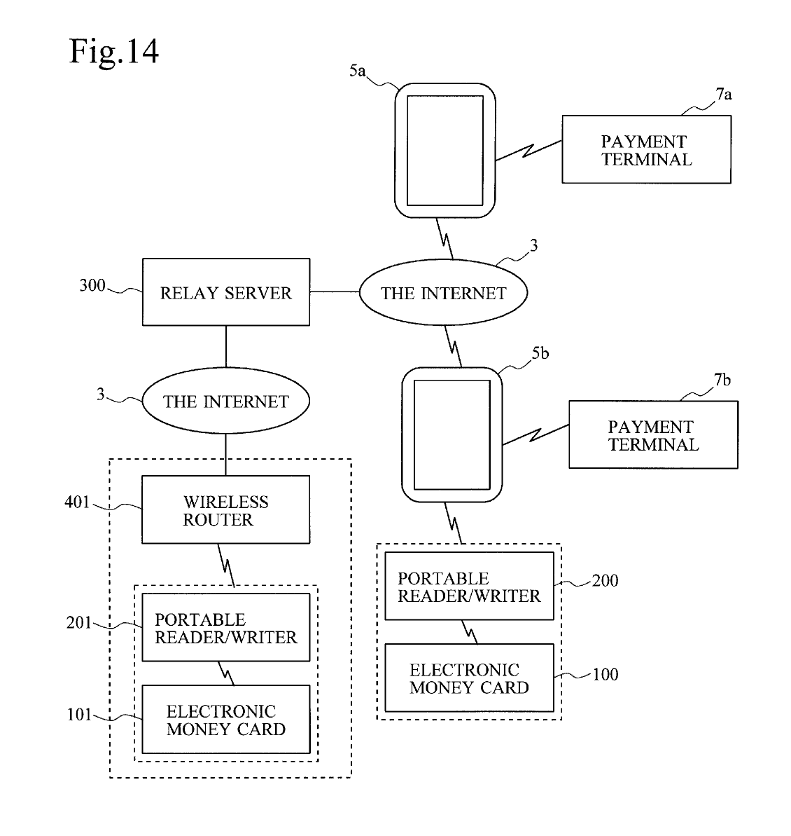

FIG. 14 is a diagram for explaining a third modified example.

In this modified example, a plurality of portable terminals 5 share one electronic money card (or may share an electronic money account installed in the electronic money server 2).

In an example of the drawing, both portable terminals 5a and 5b register the electronic money card 101 as a device with which connection is to be established and can perform payment separately with payment terminals 7a and 7b by using the electronic money card 101.

As a result, a mode of operation in which, for example, the portable reader/writer 201 to which the electronic money card 101 is fitted is kept in user's home and a parent and a child share it becomes possible.

Moreover, since the portable terminal 5b registers the electronic money cards 100 and 101 as a device with which connection is to be established, the portable terminal 5b can perform payment by selecting any one of these electronic money cards.

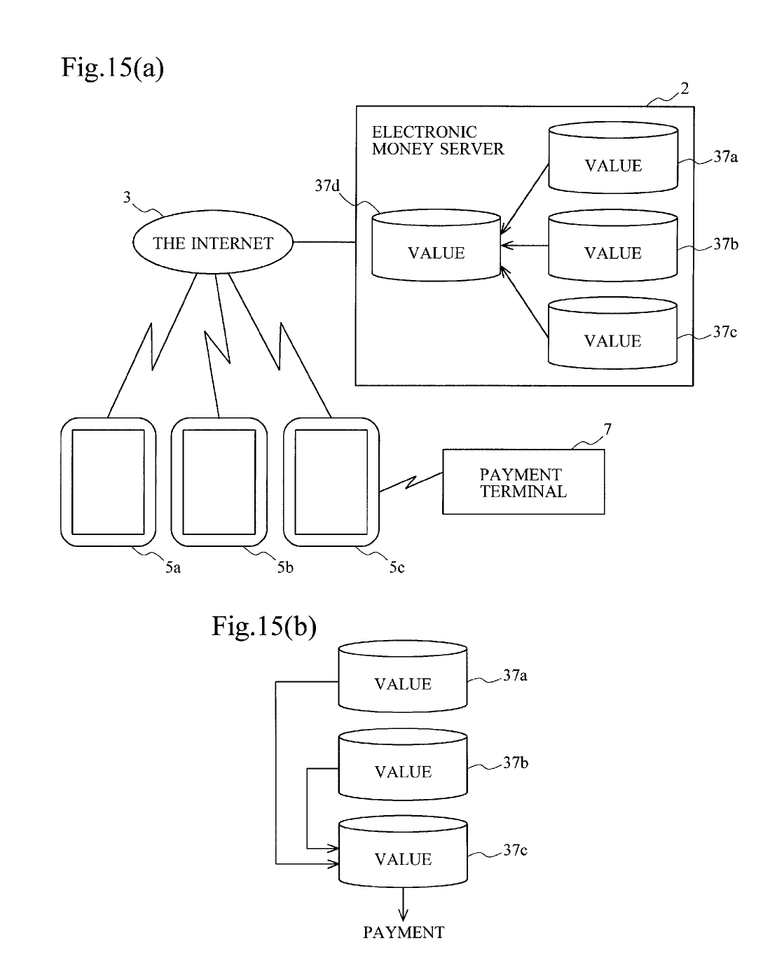

FIG. 15 is a diagram for explaining a fourth modified example.

In this modified example, payment performed by a plurality of portable terminals 5 is performed by one portable terminal 5 representing the plurality of portable terminals 5. In this configuration, for example, when people eat and drink in a group and the amount for food and drink is paid by so-called splitting the bill among the members of the group, payment processing is required only one time, making it possible to improve the convenience of users and the store.

As depicted in FIG. 15 (a), the users of portable terminals 5a, 5b, and 5c respectively have, in the electronic money server 2, electronic money accounts formed of electronic money storing sections 37a, 37b, and 37c.

Moreover, the users of the portable terminals 5a, 5b, and 5c have a shared electronic money account formed of an electronic money storing section 37d.

That is, the portable terminal 5a can access the electronic money storing section 37a and the electronic money storing section 37d, the portable terminal 5b can access the electronic money storing section 37b and the electronic money storing section 37d, and the portable terminal 5c can access the electronic money storing section 37c and the electronic money storing section 37d.

In such a configuration, the users of the portable terminals 5a, 5b, and 5c transfer value corresponding to the amounts which the users have to pay to the electronic money storing section 37d by operating their respective portable terminals 5a, 5b, and 5c.

Then, when the user of the portable terminal 5c acts as a representative payer, the user of the portable terminal 5c connects the portable terminal 5c to the electronic money storing section 37d and the payment terminal 7 and performs payment by using the value balance of the electronic money storing section 37d.

Incidentally, in the above example, a device with which connection is to be established, the device which is a source of transfer, is assumed to be the electronic money server 2, but an electronic money card may be set as a device with which connection is to be established, the device which is a source of transfer.

For example, when the portable terminal 5a registers the electronic money card 100 as a device with which connection is to be established, the portable terminal 5a can transfer value corresponding to the amount which the user of the portable terminal 5a has to pay to the electronic money storing section 37d from the electronic money card 100 by connecting to the portable reader/writer 200 to which the electronic money card 100 is fitted and the electronic money server 2.

In this case, the electronic money account functions as a balance storing unit that stores the balance of electronic value in a state in which the balance is related to a user.

In addition, the electronic money server 2 includes a group setting unit that sets a group of a plurality of users in order to set a user who performs payment based on the access from the portable terminals 5a to 5c.

Furthermore, the electronic money server 2 includes a balance change information receiving unit that receives balance change information which reduces the balance of electronic value via the portable terminal of one user included in the set group in order to receive balance change information via the portable terminal 5c, for example.

In addition, since the electronic money server 2 reduces value from the electronic money accounts of the users of the portable terminals 5a to 5c such that the total amount becomes equal to the payment amount, the electronic money server 2 includes a reducing unit that reduces each of the balances of electronic value corresponding to the users included in the set group such that the total value of the reduction amounts becomes equal to the reduction amount specified by the received balance change information.

FIG. 15(b) is a diagram for explaining another configuration of this modified example.

In an example of FIG. 15(b), the user of the portable terminal 5a transfers value corresponding to the amount which the user of the portable terminal 5a has to pay to the electronic money storing section 37c of the user of the portable terminal 5c who is a representative payer from the electronic money storing section 37a of the user of the portable terminal 5a by operating the portable terminal 5a. The user of the portable terminal 5b does transfer in the same manner.

Then, the portable terminal 5c is connected to the electronic money storing section 37c and the payment terminal 7 and payment is performed by using the value balance of the electronic money storing section 37c.

In the above description, a case where payment is performed by using the portable terminal 5 has been explained; next, a case where recharging is performed by using the portable terminal 5 will be explained.

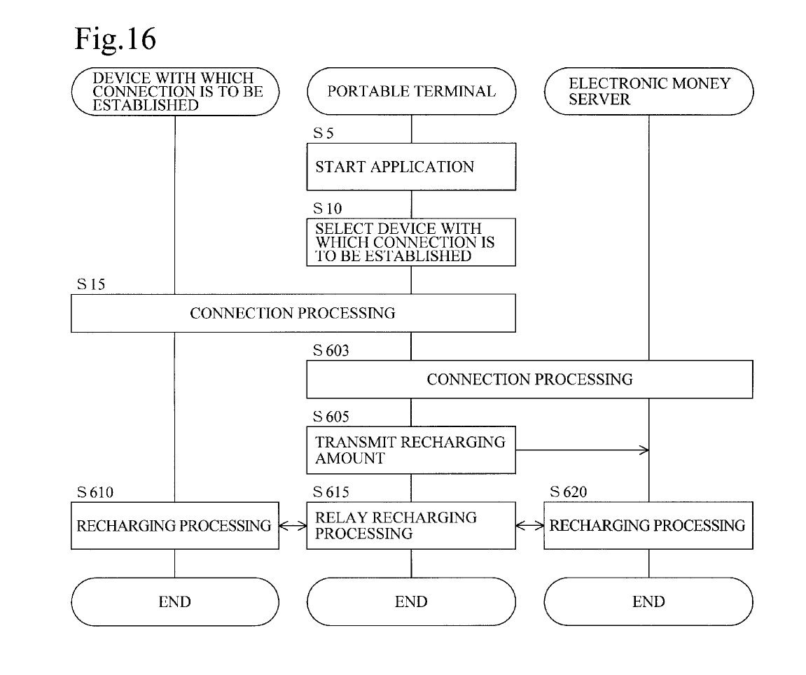

FIG. 16 is a flowchart for explaining the procedures which are performed when recharging is performed.

Here, it is assumed that the user of the portable terminal 5 makes a contract with a credit company and the electronic money server 2 charges a server of the credit company for the cost of recharging by performing communication with the server of the credit company.

The same steps as those of FIG. 8 are identified with the same step numbers and the explanations thereof are simplified or omitted.

After the portable terminal 5 starts an application (Step 5), the portable terminal 5 selects a device with which connection is to be established, the device on which recharging is to be performed (Step 10), and performs connection processing (Step 15).

Next, the portable terminal 5 connects to the electronic money server 2 (Step 603). At this time, the electronic money server 2 performs user authentication and identifies the user.

Next, the portable terminal 5 transmits a recharging amount to the electronic money server 2 and requests the electronic money server 2 to perform recharging (Step 605).

As described above, the portable terminal 5 includes a requesting unit that requests balance change information which increases the balance of electronic value by a predetermined amount from a balance changing device (the electronic money server 2) with which connection has been established.

Then, the portable terminal 5 starts relaying between the electronic money server 2 and the device with which connection is to be established.

When receiving the request for recharging, the electronic money server 2 generates balance change information which increases value by the recharging amount and transmits the balance change information to the device with which connection is to be established, and the device with which connection is to be established performs recharging processing by increasing the value balance in accordance with this balance change information (Steps 610 and 620). During that time, the portable terminal 5 relays recharging processing (Step 615).

In this way, the portable terminal 5 can perform recharging on the device with which connection is to be established by using radio communication.

Incidentally, in the above example, recharging is performed by the electronic money server 2, but recharging can also be performed from the payment terminal 7.

In this case, the user pays money for recharging and asks a person in charge of the store to perform recharging.

Then, the user makes the portable terminal 5 relay communication between a device with which connection is to be established and the payment terminal 7, and balance change information for performing recharging on the device with which connection is to be established is transmitted from the payment terminal 7.

As described above, the relaying unit relays the balance change information transmitted from the balance changing device in response to the request to the electronic value storage device.

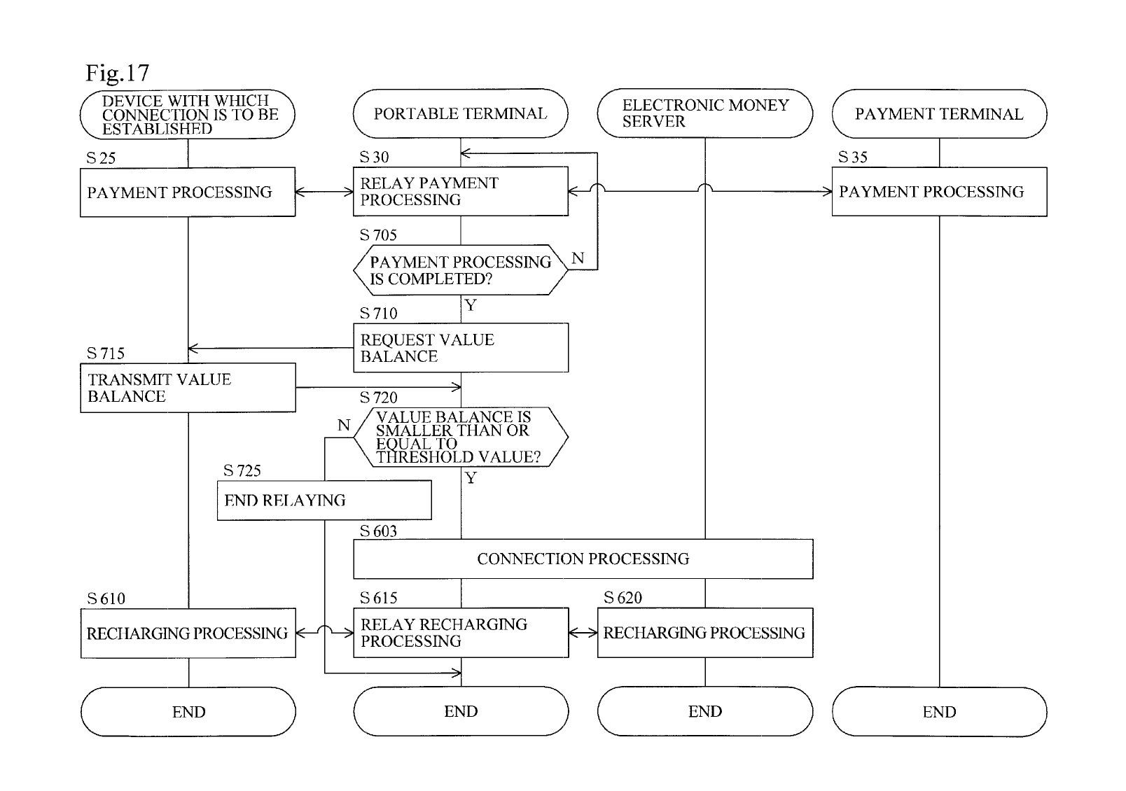

FIG. 17 is a flowchart for explaining a modified example when recharging is performed.

In this example, after the portable terminal 5 relays payment processing between a device with which connection is to be established and the payment terminal 7, the portable terminal 5 checks the value balance of the device with which connection is to be established, and, if the value balance is smaller than or equal to a predetermined threshold value, the portable terminal 5 automatically performs recharging by connecting the device with which connection is to be established and the electronic money server 2.

The same step numbers as those of FIGS. 8 and 16 are assigned and explanations are simplified or omitted.

The portable terminal 5 monitors communication between the device with which connection is to be established and the payment terminal 7 (but the portable terminal 5 cannot understand the contents thereof because the contents are encrypted) while relaying payment processing (Step 25, Step 35) which is performed by the device with which connection is to be established and the payment terminal 7 (Step 30) and determines whether or not the payment processing is completed (Step 705). As for this determination, for example, the portable terminal 5 determines that the payment processing is completed when the portable terminal 5 detects that the communication between the device with which connection is to be established and the payment terminal 7 ceases.

If the payment processing is not completed (Step 705; N), the portable terminal 5 continues monitoring the communication in Step 30; if the payment processing is completed (Step 705; Y), the portable terminal 5 ends relaying with the payment terminal 7 and requests a notification of the value balance from the device with which connection is to be established (Step 710).

The following processing continues after the user removes the portable terminal 5 from the reader/writer section 139 of the payment terminal 7 at the completion of payment.

In response to the request for the value balance, the device with which connection is to be established reads the value balance after payment and transmits the value balance to the portable terminal 5 (Step 715).

When receiving the value balance from the device with which connection is to be established, the portable terminal 5 determines whether or not this value balance is smaller than or equal to a predetermined threshold value (Step 720). The user can arbitrarily set this threshold value.

If the value balance is greater than the predetermined threshold value (Step 720; N), the portable terminal 5 ends the relay processing with the device with which connection is to be established (Step 725). This ends all the processing which follows.

On the other hand, if the value balance is smaller than or equal to the predetermined threshold value (Step 720; Y), the payment terminal 7 connects to the electronic money server 2 while maintaining the connection with the device with which connection is to be established (Step 603) and performs authentication and so forth.

Next, the portable terminal 5 relays recharging processing between the device with which connection is to be established and the electronic money server 2 (Step 615), and the device with which connection is to be established and the electronic money server 2 perform recharging processing (Steps 610 and 620). The user can set a recharging amount, such as 2000 yen per processing, in the electronic money server 2 in advance.

By the above processing, the portable terminal 5 can automatically perform recharging when the value balance is reduced as a result of payment.

In the above embodiment and modified examples, the embodiment and modified examples are applied to a brick-and-mortar store in which the payment terminal 7 is installed, but the embodiment and modified examples can also be applied to a cyber-store which is operated via the Internet 3.

In this case, the payment terminal 7 and the reader/writer section 139 serve as a server device in which a payment system of the cyber-store is installed.

With the embodiment and modified examples described above, it is possible to obtain the following effects.

(1) By using the relaying function of the portable terminal 5, it is possible to perform payment by using value even when the portable terminal 5 is not provided with an IC module 30.

(2) By fitting the electronic money card 100 to the portable reader/writer 200, the electronic money card 100 is provided with the radio communication function, and, by connecting the portable terminal 5 and the electronic money card 100 by a radio channel, it is possible to receive electronic money service without being restricted by a location.

(3) The portable terminal 5 can select a device to be used from a plurality of devices with which connection is to be established.

(4) It is possible to perform flexible operation according to the circumstances, such as assigning priorities to a plurality of devices with which connection is to be established.

### EXPLANATIONS OF LETTERS OR NUMERALS

1 electronic money system
2 electronic money server
3 the Internet
5 portable terminal
7 payment terminal
8 communication line
11 CPU
12 ROM
13 RAM
14 input section
15 output section
16 communication controlling section
17 short-distance communication controlling section
18 storing section
19 bus line
20 reader/writer communication controlling section
30 IC module
31 CPU
32 ROM
33 RAM
34 communication controlling section
35 storing section
36 bus line
37 electronic money storing section
100 to 102 electronic money card
121 CPU
122 high-frequency circuit
123 ROM
124 RAM
125 storing section
126 antenna
127 bus line
129 electronic money storing section
131 CPU
133 ROM
134 RAM
135 communication controlling section
136 storing section
137 input section
138 output section
139 reader/writer section
144 data storage section
200 to 202 portable reader/writer
231 CPU
232 ROM
233 RAM
234 short-distance communication controlling section
235 storing section
236 reader/writer communication controlling section
238 bus line
300 relay server
401, 402 wireless router
A to C electronic wallet

1-15. (canceled)

16. A portable device comprising:
a first connecting unit that communicability connects with a payment device having a unit that stores predetermined data and a unit that executes predetermined processing and outputs response information, the predetermined processing related to the predetermined data based on request information which is input from an external device; and
a second connecting unit that communicability connects, after being connected by the first connecting unit, with an accepting device having a unit that inputs request information into a nearby device and a unit that accepts response information corresponding to the request information from the nearby device; and
a relaying unit that relays, when being connected by the second connecting unit, the request information from the accepting device and the response information from the payment device.

17. The portable device according to claim 16, further comprising:
a detecting unit that detects a usable payment device of the plurality of payment devices; and
a specifying unit that specifies, from among the payment devices detected by the detecting unit, a payment device which is to be connected to the accepting device by relaying.

18. The portable device according to claim 17, wherein
when a plurality of payment devices are detected by the detecting unit, the specifying unit preferentially specifies a payment device with a relatively high degree of priority in connecting the payment device to the accepting device, a degree of priority which is determined in accordance with a classification depending on the network environment of the accepting device.

19. The portable device according to claim 18, wherein
after connecting to the accepting device, the specifying unit preferentially specifies a payment device with a relatively high degree of priority, the degree of priority which is determined in accordance with a classification of the accepting device which is identified based on data which is acquired from the accepting device.

20. The portable device according to claim 19, further comprising:
a plurality of relaying units which are different from one another,
wherein
the detecting unit detects a payment device which is connectable to any one of the plurality of relaying units, and
the specifying unit preferentially specifies a payment device which is connected to a relaying unit which relatively easily increases the degree of priority.

21. The portable device according to claim 20, wherein
the plurality of relaying units connect to the payment device in connection configurations which are different from one another,
the classification includes one or more than one classification which gives priority to a required time of a transaction, and
if the classification of the accepting device with which connection has been established corresponds to the classification which gives priority to the required time, the specifying unit preferentially specifies a payment device which connects to a relaying unit with a connection configuration whose degree of shortening the required time is relatively high.

22. The portable device according to claim 21, wherein
if the classification of the accepting device with which connection has been established does not correspond to the classification which gives priority to the required time, the specifying unit preferentially specifies a payment device which connects to a relaying unit with a connection configuration whose degree of enhancing an availability of the payment device is relatively high.

23. The portable device according to claim 21, wherein
if the classification of the accepting device with which connection has been established does not correspond to the classification which gives priority to the required time, the specifying unit preferentially specifies a payment device which does not relatively easily enter an unpayable state.

24. The portable device according to claim 16, wherein
the plurality of payment devices include a portable payment device which is fitted to a relaying unit connectable to a public communication network, and
the detecting unit transmits inquiry information to the portable payment device fitted to the relaying unit via the public communication network and the relaying unit and determines that the portable payment device is usable if reply information to the inquiry information is acquired.

25. The portable device according to claim 24, further comprising:
a unit that makes a holding unit hold key information for being authenticated by a transfer restricting unit that restricts data which is transferred to the portable payment device to data from a device authenticated by predetermined key information; and
a unit that presents the held key information to be authenticated by the transfer restricting unit.

26. The portable device according to claim 25, wherein
the unit that makes the holding unit hold the key information makes the holding unit hold the key information which is generated in pairing processing for pairing with the relaying unit having the transfer restricting unit.

27. The portable device according to claim 16, wherein
the plurality of payment devices include a server-side payment device having a unit that stores information necessary to establish connection with one or more than one relaying unit connectable to a public communication network and an outputting unit that executes balance change processing which changes a balance of electronic value which is stored in a portable payment device by inputting balance change information to the portable payment device which is fitted to or built into the one or more than one relaying unit which is connected via the public communication network by the information necessary to establish connection based on the request information which is input from an external device and outputs the response information, and
the detecting unit transmits inquiry information to the server-side payment device and, if reply information to the inquiry information is acquired, the detecting unit determines that the server-side payment device is usable.

28. The portable device according to claim 27, further comprising:
a unit that provides, to the specified server-side payment device, key information which is temporarily valid, the key information which is generated in pairing processing with the relaying unit having a transfer restricting unit that restricts data which is transferred to each portable payment device to data including predetermined key information,
wherein
the outputting unit of the specified server-side payment device attaches the provided key information corresponding to each portable payment device to balance change information which is input to the one or more than one portable payment device via the relaying unit.

29. The portable device according to claim 17, further comprising:
a storing unit that temporarily stores a balance of electronic value from all the plurality of payment devices detected by the detecting unit with which connection is to be established; and
when inputting the request information from the accepting device, the specifying unit immediately specifies a device with which connection should be established based on the temporarily stored value balances of plurality of payment devices.

30. The portable device according to claim 17, further comprising:
a divided payment amount determining unit that determines a divided payment amount for each of the plurality of payment devices with which connection is to be established such that the total value of the divided payment amount becomes equal to the payment amount.

31. A plurality of portable devices according to claim 16 are present, wherein
each of the plurality of portable devices share one electronic money card as the payment device with which connection is to be established and can perform payment separately with the payment device by using the electronic money card.

32. The portable devices according to claim 31, wherein
the payment performed by a plurality of portable devices is performed by one device representing them.

33. A method for controlling a portable device, comprising:
a first connecting step of communicability connecting with a payment device having a unit that stores predetermined data and a unit that executes predetermined processing and outputs response information, the predetermined processing related to the predetermined data based on request information which is input from an external device; and
a second connecting step of communicability connecting, after the first connecting step, with an accepting device having a unit that inputs request information into a nearby device and a unit that accepts response information corresponding to the request information from the proximity device; and
a relaying step of relaying, after the second connecting step, the request information from the accepting device and the response information from the payment device.

34. A non-transitory recording medium on which a program is recorded, the program that makes a computer implement:
a first connecting function of communicability connecting with a payment device having a unit that stores predetermined data and a unit that executes predetermined processing and outputs response information, the predetermined processing related to the predetermined data based on request information which is input from an external device; and
a second connecting function of communicability connecting, after the first connecting function, with an accepting device having a unit that inputs request information into a nearby device and a unit that accepts response information corresponding to the request information from the proximity device; and
a relaying function of relaying, after the second connecting function, the request information from the accepting device and the response information from the payment device.
